(19) United States
(12) Patent Application Publication
(10) Pub. No.: US 2024/0380245 A1
(43) Pub. Date: Nov. 14, 2024

(54) CHARGER FOR FACILITATING CHARGING OF SMARTWATCH

(71) Applicant: ZHIKAI ZHANG, Shenzhen (CN)

(72) Inventors: ZHIKAI ZHANG, Shenzhen (CN); XUAN ZHANG, Shenzhen (CN)

(21) Appl. No.: 18/640,329

(22) Filed: Apr. 19, 2024

(30) Foreign Application Priority Data
May 10, 2023 (CN) 202321111487.1

(51) Int. Cl. H02J 50/10; G04C 10/00; H02J 7/00; H02J 50/90

(52) U.S. Cl. CPC H02J 50/10; G04C 10/00; H02J 7/0044; H02J 50/90

(57) ABSTRACT

The present disclosure discloses a charger for facilitating charging of a smartwatch, including a charger body and a wireless charging structure, wherein a recess is disposed on a surface of the charger body; and an end of the wireless charging structure is connected to the charger body, and the wireless charging structure is flipped and collected in the recess. According to the present disclosure, connection to the wireless charging structure can be achieved by means of a magnetic attraction property to thus allow for charging and fixation; the wireless charging structure also has a flip feature and can be flipped and pulled out of the recess; and a user can make adjustment according to his/her own usage scenario, such that a dial plate of the smartwatch faces towards the user all the time to facilitate acquisition of information of the dial plate, which increases convenience during charging.

### CROSS-REFERENCE TO RELATED APPLICATIONS

This application claims priority to Chinese Patent Application No. 202321111487.1, filed on May 10, 2023, which is hereby incorporated by reference in its entirety.

### TECHNICAL FIELD

The present disclosure relates to the field of charger structures, and in particular to a charger for facilitating charging of a smartwatch.

### BACKGROUND

With the development of science and technology, smartwatches are favored by people due to their small size and rich functions. As power-consuming components, the smartwatches accordingly need to be supplemented with electric energy in time. In the prior art, for example, a China Utility Model with application Ser. No. 20/212,2603291.1 correspondingly discloses a charger with a watch charging function, where a charging plug body is equipped with a wireless charging device, with which a body portion of a smartwatch comes into contact during charging of the smartwatch, such that the body portion of the smartwatch can stably fit a charging plug body under the action of magnetic attraction to enable charging of the smartwatch. In the above structural solution, the smartwatch can be charged more conveniently. However, it is found in actual use that the cooperation between the wireless charging device and the charging plug body is single and unadjustable, and when needing to know the charging status of the smartwatch, a user cannot quickly acquire information displayed on the smartwatch and often needs manual assistance, once a socket is not placed flat on a tabletop. The overall operation is cumbersome, and the requirement for the position of the socket is also stringent. Therefore, there is a need for a charger with a more rational structure to overcome the existing defects described above.

### SUMMARY

In view of the technical problem that, in the existing charger, the cooperation between the wireless charging device and the charger body is single and the display interface of the smartwatch cannot be kept facing the user all the time during charging, the present application provides a solution.

To achieve the above object, the present disclosure provides a charger for facilitating charging of a smartwatch, including:
a charger body, in which a master control board is disposed, wherein one end of the charger body is provided with an electric plug electrically connected to the master control board, the other end of the charger body is provided with an electric interface electrically connected to the master control board, and a recess is disposed on a surface of the charger body; and
a wireless charging structure, an end of which is connected to the charger body, wherein the wireless charging structure is flipped and collected in the recess, and the wireless charging structure is electrically connected to the master control board.

As an improvement of the present disclosure, the charger body includes a first housing and a second housing, which are closed to form an accommodation cavity for accommodating the master control board; and the recess is located on a surface of the second housing away from the first housing.

As an improvement of the present disclosure, a mounting plate is disposed between the first housing and the second housing, and the recess takes the mounting plate as a bottom; a first rotary column and a second rotary column are disposed on two opposing sides of an end of the wireless charging structure, rotation holes are formed jointly by the first housing and the mounting plate on inner walls on two sides of the formed recess, and the first rotary column and the second rotary column are disposed in the rotation holes on the same side, respectively.

As an improvement of the present disclosure, two sets of mounting protrusions are further disposed on a surface of the mounting plate away from the first housing; first rotation slots are disposed on opposing surfaces of the two sets of mounting protrusions; the second housing is further correspondingly provided with two sets of second rotation slots; the first and second rotation slots on the same side jointly form the rotation hole; and the first rotary column and the second rotary column are each in interference fit in the rotation hole on the same side.

As an improvement of the present disclosure, a silica gel slot is disposed on a surface of each the two sets of mounting protrusions away from the first housing; silica gel pads are disposed in the silica gel slots; and the first rotation slots correspondingly extend onto the silica gel pads on the same side.

As an improvement of the present disclosure, the first rotary column and the second rotary column are each provided with ribs connected to both ends; and the first rotation slots are provided with elongated grooves adapted to the ribs.

As an improvement of the present disclosure, the wireless charging structure includes a charging panel and a flip arm; one end of the flip arm is connected to the charging panel, and two opposing sides of the other end of the flip art are provided with the first rotary column and the second rotary column; a first magnetic unit is further disposed on a surface of the mounting plate away from the first housing, a second magnetic unit adapted to the first magnetic unit is disposed on the charging panel; and when the charging panel is accommodated in the recess, the first magnetic unit fits the second magnetic unit.

As an improvement of the present disclosure, a beveled structure is further disposed on an end of the flip arm away from the charging panel; and when the flip arm is completely flipped, an end surface of the end of the flip arm away from the charging panel fits the mounting plate.

As an improvement of the present disclosure, the charger further includes a butting cover, wherein both ends of the butting cover are bent toward a middle part to allow for sliding connection to both sides of the charger body, the butting cover is disposed on an end of the charger body close to the electric plug; and butting ridges are disposed on a surface of the butting cover away from the charger body.

As an improvement of the present disclosure, the charger further includes a butting column, wherein the charger body is further provided with a chute allowing for extension of the butting column to a surface.

The present disclosure has the following advantageous effects: compared with the prior art, the present disclosure provides a charger for facilitating charging of a smartwatch, including a charger body and a wireless charging structure; a master control board is disposed in the charger body, one end of the charger body is provided with an electric plug electrically connected to the master control board, and the other end of the charger body is provided with an electric interface electrically connected to the master control board; a recess is disposed on a surface of the charger body; one end of the wireless charging structure is connected to the charger body, and the wireless charging structure is flipped and collected in the recess; the wireless charging structure is electrically connected to the master control board; and in a case where a socket is not disposed flat, the smartwatch is connected to the wireless charging structure simply by means of a magnetic attraction property to thus allow for charging and fixation; further, the wireless charging structure also has a flip feature and can be flipped and pulled out of the recess; and a user can make adjustment according to his/her own usage scenario, such that a dial plate of the smartwatch faces towards the user all the time to facilitate acquisition of information displayed by the dial plate, which increases convenience during charging.

### BRIEF DESCRIPTION OF DRAWINGS

FIG. 1 shows a stereogram according to the present disclosure;

FIG. 2 shows an exploded view according to the present disclosure;

FIG. 3 shows a diagram of a mounting plate according to the present disclosure;

FIG. 4 shows a schematic diagram of a mounting plate and a wireless charging structure according to another embodiment of the present disclosure;

FIG. 5 shows a stereogram of a butting cover according to the present disclosure;

FIG. 6 shows a stereogram of a butting column according to the present disclosure;

FIG. 7 shows a stereogram of a second housing according to the present disclosure; and

FIG. 8 shows a diagram of usage state according to the present disclosure in a use state.

The reference signs of main elements are illustrated as follows:

1, charger body; 11, electric plug; 12, electric interface; 13, recess; 14, first housing; 15, second housing; 151, second rotation slot;

2, wireless charging structure; 21, first rotary column; 22, second rotary column; 23, rib;

24, charging panel; 25, flip arm; 26, second magnetic unit;

3, mounting plate; 31, mounting protrusion; 32, first rotation slot; 321, elongated groove; 33, silica gel pad; 34, first magnetic unit;

4, butting cover; 41, butting ridge;

5, butting column;

6, smartwatch.

### DESCRIPTION OF EMBODIMENTS

To more clearly state the present disclosure, the following further describes the present disclosure in conjunction with the accompanying drawings.

The description below gives the details of common instances to provide a more in-depth understanding of the present disclosure. Obviously, the described embodiments are some but not all of the embodiments of the present disclosure. It should be understood that the specific embodiments are merely for explaining the present disclosure, and are not intended to limit the present disclosure.

It should also be understood that, when the terms “comprise” and/or “include” are used in the Description, they indicate the presence of the stated feature, entirety, step, operation, element or assembly, but do not exclude the presence or addition of one or more other features, entireties, steps, operations, elements, assemblies or their combinations. Now, the exemplary embodiments according to the present disclosure will be described in more detail with reference to the accompanying drawings.

In the prior art, for example, a China Utility Model with application Ser. No. 20/212,260329.1 correspondingly discloses a charger with a watch charging function, where a charging plug body is equipped with a wireless charging device, with which a body portion of a smartwatch comes into contact during charging of the smartwatch, such that the body portion of the smartwatch can stably fit a charging plug body under the action of magnetic attraction to enable charging of the smartwatch. In the above structural solution, the smartwatch can be charged more conveniently. However, it is found in actual use that the cooperation between the wireless charging device and the charging plug body is single and unadjustable, and when needing to know the charging status of the smartwatch, a user cannot quickly acquire information displayed on the smartwatch and often needs manual assistance, once a socket is not placed flat on a tabletop. The overall operation is cumbersome, and the requirement for the position of the socket is also stringent. Therefore, there is a need for a charger with a more rational structure to overcome the existing defects described above.

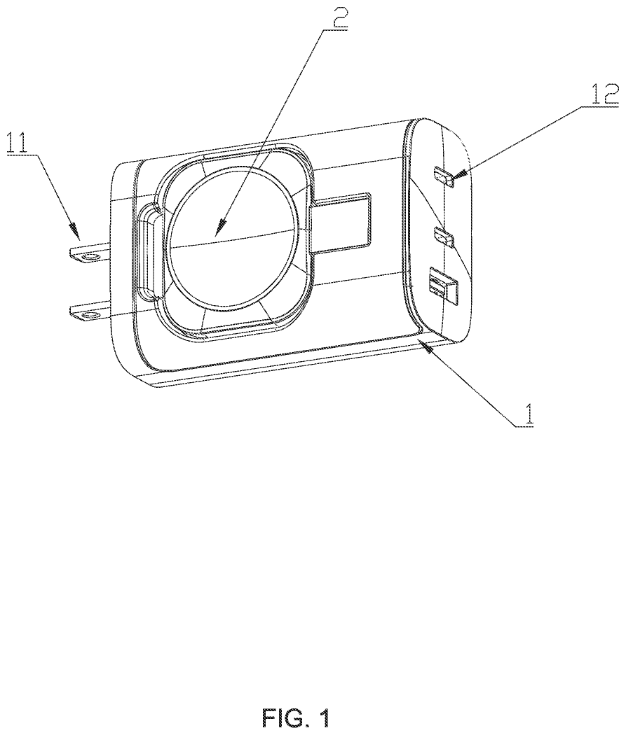

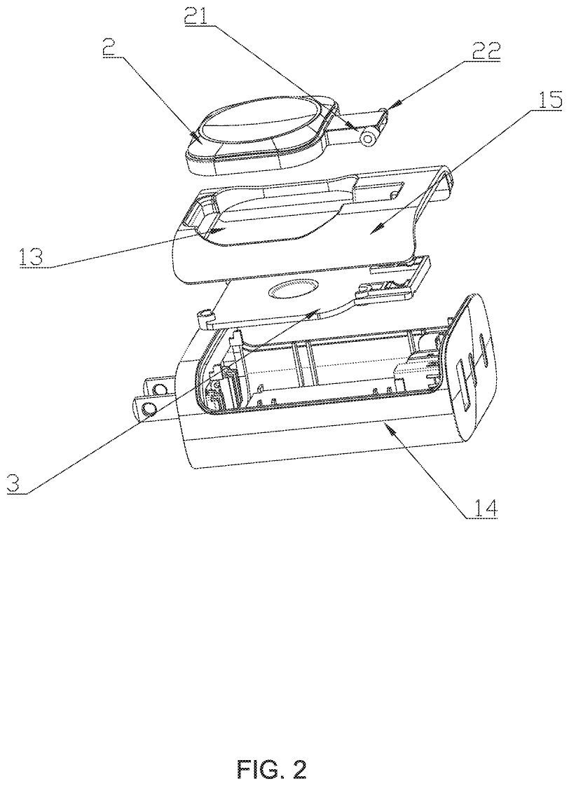

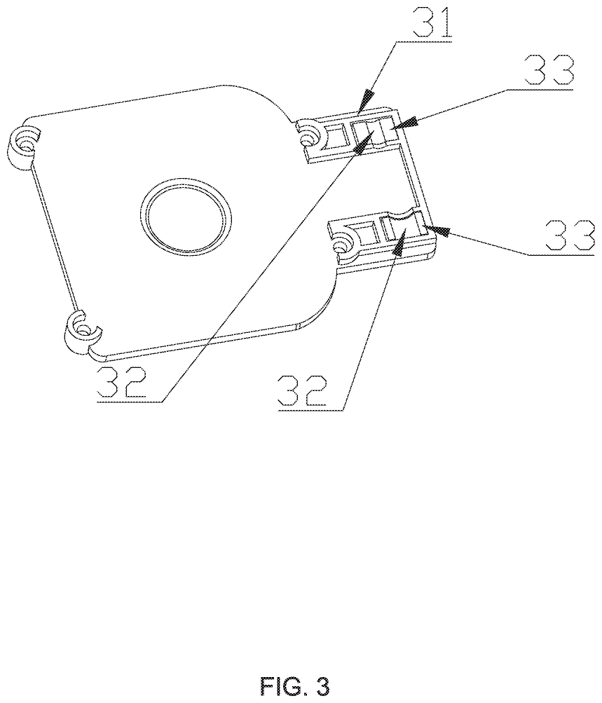

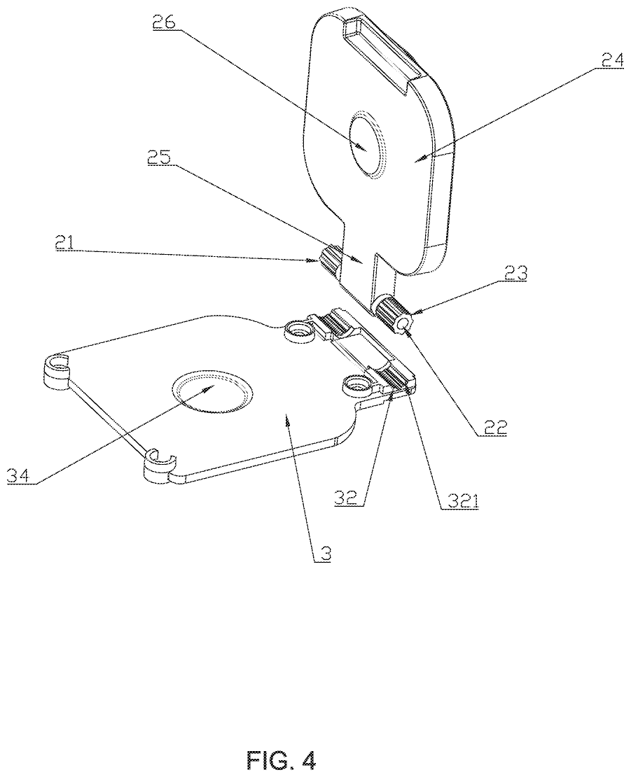

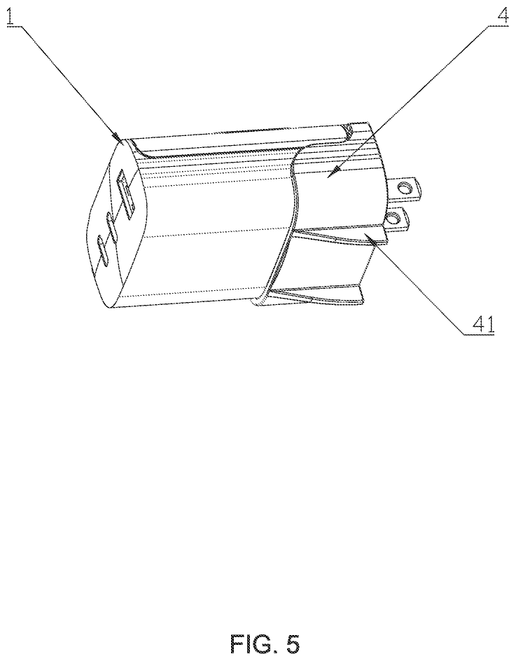

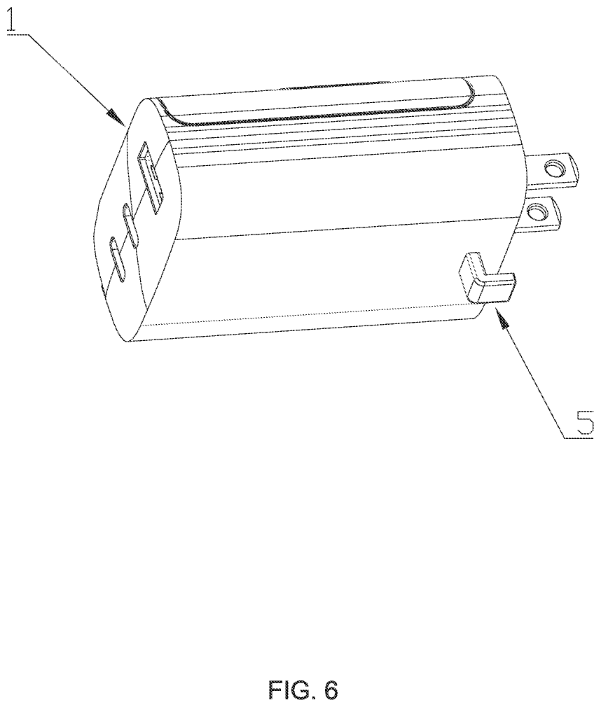

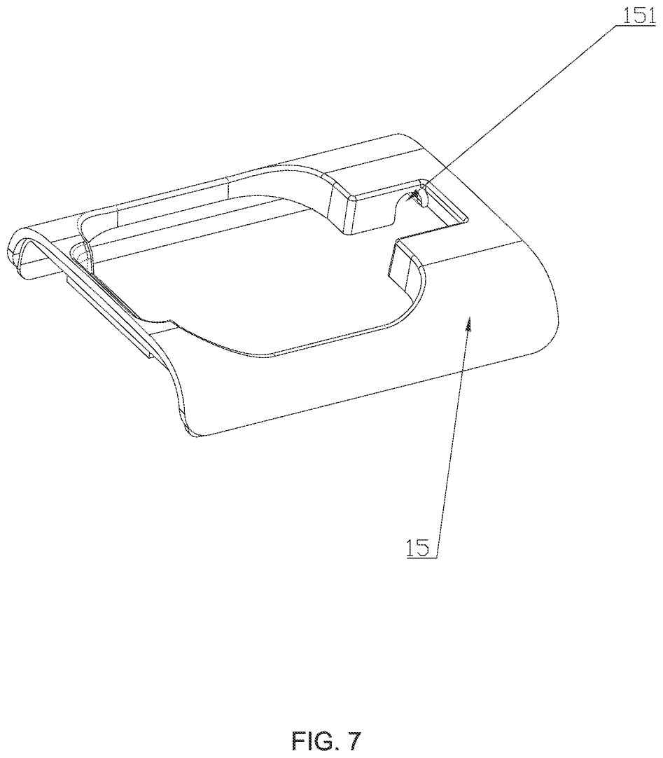

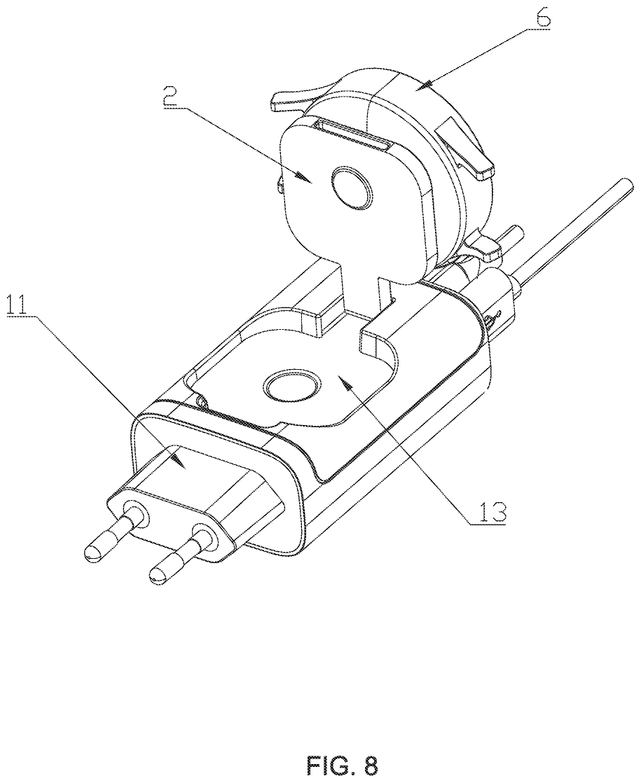

To solve the technical problems mentioned above, the present disclosure provides a charger for facilitating charging of a smartwatch 6. Referring to FIG. 1 to FIG. 8, the charger includes a charger body 1 and a wireless charging structure 2, where a master control board is disposed in the charger body 1, one end of the charger body 1 is provided with an electric plug 11 electrically connected to the master control board, and the other end of the charger body 1 is provided with an electric interface 12 electrically connected to the master control board. The electric plug 11 may be a standard plug type complying with the standards of different countries, such as China, Europe, or the US; and the electric interface 12 may be disposed as a USB interface, Type-C or the like, and a plurality of electric interfaces 12 may be arranged, the number of which is not limited. A recess 13 is disposed on a surface of the charger body 1. One end of the wireless charging structure 2 is connected to the charger body 1, and the wireless charging structure is flipped and collected in the recess 13; and the wireless charging structure 2 is electrically connected to the master control board. In a case where a socket is not disposed flat, the smartwatch 6 is connected to the wireless charging structure 2 simply by means of a magnetic attraction property to thus allow for charging and fixation. Further, the wireless charging structure 2 also has a flip feature and can be flipped and pulled out of the recess. A user can make adjustment according to his/her own usage scenario, such that a dial plate of the smartwatch 6 faces towards the user all the time to facilitate acquisition of information displayed by the dial plate, which increases convenience during charging.

To further optimize the structure of the charger body, in this embodiment, the charger body 1 includes a first housing 14 and a second housing 15, which are closed to form an accommodation cavity for accommodating the master control board; and the recess 13 is located on a surface of the second housing 15 away from the first housing. It is readily understandable that the accommodation cavity can accommodate and protect the master control board, and the recess 13 is formed in the second housing 15 to accommodate the wireless charging structure 2, such that the overall volume of the charger can be effectively reduced to achieve portability.

To further optimize the rationality in assembling the charger body 1 and the wireless charging structure 2, in this embodiment, a mounting plate 3 is disposed between the first housing 14 and the second housing 15, and the recess 13 takes the mounting plate 3 as a bottom; a first rotary column 21 and a second rotary column 22 are disposed on two opposing sides of an end of the wireless charging structure 2, rotation holes are formed jointly by the second housing 15 and the mounting plate 3 on inner walls on two sides of the formed recess 13, and the first rotary column 21 and the second rotary column 22 are disposed in the rotation holes on the same side, respectively. It is readily understandable that the mounting plate 3 may be fixed onto an inner wall of the first housing 14 by means of bolts; a surface of the mounting plate 2 away from the first housing 14 is configured for supporting and mounting of the wireless charging structure 2; and with regard to mounting, since the rotation holes are formed jointly by the mounting plate 3 and the second housing 15, the mounting can be completed simply by placing the first rotary column 21 and the second rotary column 22 correspondingly at positions on the mounting plate and then closing the second housing, thereby achieving simplicity in assembly.

To further optimize the rationality in flipping the wireless charging structure 2, in this embodiment, two sets of mounting protrusions 31 are further disposed on a surface of the mounting plate 3 away from the first housing 14; first rotation slots 32 are disposed on opposing surfaces of the two sets of mounting protrusions 31; the second housing 15 is further correspondingly provided with two sets of second rotation slots 151; the first rotation slot 32 and the second rotation slot 151 on the same side jointly form the rotation hole; and the first rotary column 21 and the second rotary column 22 are each in interference fit in the rotation hole on the same side. The interference fit is formed by means of the rotation holes on two sides to increase damping, such that the wireless charging structure can be flipped and fixed at any angle, without easy occurrence of offset.

Due to fast iterative product update of smart terminals such as the smartwatch 6, weight parameters will always change with the products. To enable the achievement of a better flipping and positioning effect, in this embodiment, a silica gel slot is disposed on a surface of each the two sets of mounting protrusions 31 away from the first housing; silica gel pads 33 are disposed in the silica gel slots; and the first rotation slots 32 correspondingly extend onto the silica gel pads 33 on the same side. It is readily understandable that the silica gel pads 33 have better resilience and can provide larger and more stable damping, to thereby improve the stability achieved by the wireless charging structure 2 during flipping and increase the supporting capacity for the smartwatch 6, such that the problem of failure in keeping a flip angle due to the weight of the smartwatch 6 is avoided.

In another implementation, the first rotary column 21 and the second rotary column 22 are each provided with ribs 23 connected to both ends; and the first rotation slots 32 are provided with elongated grooves 321 adapted to the ribs 23. It is readily understandable that the first rotation slots 32 are fixed to the mounting plate 3 without looseness, and the ribs 23 and the elongated grooves 321 are embedded with each other during the rotation of the first rotary column 21 and the second rotary column 22, such that the wireless charging structure 2 can be maintained at a desired angle and the damping is further increased, to enable the wireless charging structure 2 to acquire a larger bearing capacity.

To further optimize the structure of the wireless charging structure 2, in this embodiment, the wireless charging structure 2 includes a charging panel 24 and a flip arm 25; one end of the flip arm 25 is connected to the charging panel 24, and two opposing sides of the other end of the flip arm are provided with the first rotary column 21 and the second rotary column 22; a first magnetic unit 34 is further disposed on a surface of the mounting plate 3 away from the first housing, a second magnetic unit 26 adapted to the first magnetic unit 34 is disposed on the charging panel; and when the charging panel 24 is accommodated in the recess, the first magnetic unit 34 fits the second magnetic unit 26. It is readily understandable that a wireless charging coil and a charging chip in the charging panel 24 perform matching and charging after sensing the approaching smartwatch 6; and the flip art 25 is configured to flip the charging panel, and the first magnetic unit 34 and the second magnetic unit 26 in a collection state improve the overall stability of the charger, such that the wireless charging structure is not prone to overturn easily.

To further optimize the wireless charging structure 2, in this embodiment, a beveled structure is further disposed on an end of the flip arm 25 away from the charging panel; and when the flip arm 25 is completely flipped, an end surface of the end of the flip arm 25 away from the charging panel 24 fits the mounting plate 3. It is readily understandable that the beveled structure can prevent jamming during flipping to allow for better flipping of the flip arm; and in complete flip, the end surface of the flip arm 25 fits the mounting plate 3 to further increase the stability of the flip arm, such that the smartwatch 6 can be stably placed on the wireless charging structure by means of the above structure, even in case of a socket in a wall.

In a scene with the socket in the wall, the overall center of gravity of the smartwatch 6 is easily offset to an end during charging, resulting in detachment of the charging plug from the socket. Therefore, in this embodiment, the charger further includes a butting cover 4; both ends of the butting cover 4 are bent toward a middle part to allow for sliding connection to both sides of the charger body 1, the butting cover is disposed on an end of the charger body 1 close to the electric plug 12; and butting ridges 41 are disposed on a surface of the butting cover 4 away from the charger body 1. It is readily understandable that the butting ridges 41 are butted against the wall to add acting points for the charger, such that the charger can be stably plugged in the socket in the wall.

In another embodiment, the charger further includes a butting column 5; the charger body 1 is further provided with a chute allowing for extension of the butting column to a surface. It is readily understandable that the butting column 5 can retract or extend into the chute. In use, the butting column 5 extends to the surface of the charger body 1 to facilitate butting against the wall, such that an acting point is added for the charger to allow the charger to be stably plugged in the socket in the wall.

The present disclosure has the following advantages:
the smartwatch is connected to the wireless charging structure simply by means of a magnetic attraction property to thus allow for charging and fixation; further, the wireless charging structure also has a flip feature and can be flipped and pulled out of the recess; and a user can make adjustment according to his/her own usage scenario, such that a dial plate of the smartwatch faces towards the user all the time to facilitate acquisition of information displayed by the dial plate, which increases convenience during charging.

The above disclosure only provides several specific embodiments of the present disclosure, which is not limited thereto. Any variation conceivable to a person skilled in the art shall fall within the protection scope of the present disclosure.

What is claimed is:

1. A charger for facilitating charging of a smartwatch, comprising:
a charger body, in which a master control board is disposed, wherein one end of the charger body is provided with an electric plug electrically connected to the master control board, the other end of the charger body is provided with an electric interface electrically connected to the master control board, and a recess is disposed on a surface of the charger body; and
a wireless charging structure, an end of which is connected to the charger body, wherein the wireless charging structure is flipped and collected in the recess, and the wireless charging structure is electrically connected to the master control board.

2. The charger for facilitating charging of the smartwatch according to claim 1, wherein the charger body comprises a first housing and a second housing, which are closed to form an accommodation cavity for accommodating the master control board; and the recess is located on a surface of the second housing away from the first housing.

3. The charger for facilitating charging of the smartwatch according to claim 2, wherein a mounting plate is disposed between the first housing and the second housing, and the recess takes the mounting plate as a bottom; a first rotary column and a second rotary column are disposed on two opposing sides of an end of the wireless charging structure, rotation holes are formed jointly by the first housing and the mounting plate on inner walls on two sides of the formed recess, and the first rotary column and the second rotary column are disposed in the rotation holes on the same side, respectively.

4. The charger for facilitating charging of the smartwatch according to claim 3, wherein two sets of mounting protrusions are further disposed on a surface of the mounting plate away from the first housing; first rotation slots are disposed on opposing surfaces of the two sets of mounting protrusions; the second housing is further correspondingly provided with two sets of second rotation slots; the first and second rotation slots on the same side jointly form the rotation hole; and the first rotary column and the second rotary column are each in interference fit in the rotation hole on the same side.

5. The charger for facilitating charging of the smartwatch according to claim 4, wherein a silica gel slot is disposed on a surface of each the two sets of mounting protrusions away from the first housing; silica gel pads are disposed in the silica gel slots; and the first rotation slots correspondingly extend onto the silica gel pads on the same side.

6. The charger for facilitating charging of the smartwatch according to claim 4, wherein the first rotary column and the second rotary column are each provided with ribs connected to both ends; and the first rotation slots are provided with elongated grooves adapted to the ribs.

7. The charger for facilitating charging of the smartwatch according to claim 6, wherein the wireless charging structure comprises a charging panel and a flip arm; one end of the flip arm is connected to the charging panel, and two opposing sides of the other end of the flip art are provided with the first rotary column and the second rotary column; a first magnetic unit is further disposed on a surface of the mounting plate away from the first housing, a second magnetic unit adapted to the first magnetic unit is disposed on the charging panel; and when the charging panel is accommodated in the recess, the first magnetic unit fits the second magnetic unit.

8. The charger for facilitating charging of the smartwatch according to claim 7, wherein a beveled structure is further disposed on an end of the flip arm away from the charging panel; and when the flip arm is completely flipped, an end surface of the end of the flip arm away from the charging panel fits the mounting plate.

9. The charger for facilitating charging of the smartwatch according to claim 1, further comprising a butting cover, wherein both ends of the butting cover are bent toward a middle part to allow for sliding connection to both sides of the charger body, the butting cover is disposed on an end of the charger body close to the electric plug; and butting ridges are disposed on a surface of the butting cover away from the charger body.

10. The charger for facilitating charging of the smartwatch according to claim 1, further comprising a butting column, wherein the charger body is further provided with a chute allowing for extension of the butting column to a surface.
